(19) United States
(12) Patent Application Publication
(10) Pub. No.: US 2006/0207121 A1
(43) Pub. Date: Sep. 21, 2006

(54) Laundry dryer including control panel

(75) Inventor: Jun Seok Lee, Daegu-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/377,281

(22) Filed: Mar. 17, 2006

(30) Foreign Application Priority Data
Mar. 17, 2005 (KR) 10-2005-22381

(51) Int. Cl. F26B 19/00; F26B 13/10

(52) U.S. Cl. 34/89; 34/527

(57) ABSTRACT

A dryer including a control panel is provided. A dryer includes a control panel, a display mounting part formed on the control panel and on which a display device is installed, a detachable button disposed on the display mounting part, and a button holder holding the detachable button to be detachable.

### BACKGROUND OF THE INVENTION

1. Field of the Invention

The present invention relates to a dryer, and more particularly, to a dryer including a control panel.

2. Description of the Related Art

A dryer is a major household appliance that is used to dry laundry. An example of the dryer is a drum dryer. In the drum dryer, the drying drum into which wet laundry is inserted is rotated, and thus the laundry is repetitively tumbled. Additionally, since high-temperature and dried air is flowed into the inside of the drying drum, the laundry is dried.

Specifically, drum dryers are broadly divided into a condenser dryers and vented dryers. In the condenser dryer, air, which is flowed into the inside of a drying drum, is circulated inside the condenser dryer and not expelled to the outside. In the vented dryer, air, which is flowed into the inside of a drying drum, absorbs moisture and is expelled to the outside of the vented dryer.

On the other hand, a control panel is mounted on a front of a drum dryer. A printed circuit board (PCB) is mounted on a rear of the control panel. Electronic components controlling operations of the dryer are mounted on the PCB. Specifically, the PCB includes a liquid crystal display (LCD) displaying an operation time, a light emitting diode (LED) emitting light to display an operation status, and a dial knob inputting drying conditions. Using the LED, the operation status or the operation condition is brightly displayed on a window display part. The dial knob is inserted into a groove of the control panel and protruded toward the front.

However, a prior art display device is mounted on the control panel of the dryer to display a dry status or a course, which only can be mounted with one of the LED and the LCD. For example, the display device is divided into LED-mounted products and LCD-mounted products, and thus the control panels are incompatible between the products.

Accordingly, when a design of the control panel is determined, and then products of the design are manufactured, it is difficult to change a form of the control panel. Therefore, when additional functions are added to improve performance later, it is impossible to add additional buttons to realize the functions.

Moreover, even if there are same products, an LCD control panel and an LED control panel are incompatible and thus manufactured separately. Therefore, it costs a lot to manufacture a mold for a control panel, and thus the productivity deteriorates.

### SUMMARY OF THE INVENTION

Accordingly, the present invention is directed to a dryer including a control panel that substantially obviates one or more problems due to limitations and disadvantages of the related art.

An object of the present invention is to provide a dryer including a control panel to minimize a change of a mold for manufacturing the control panel and improve compatibility and expandability of the control panel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a dryer including: a control panel; a display mounting part formed on the control panel and on which a display device is installed; a detachable button disposed on the display mounting part; and a button holder holding the detachable button to be detachable.

In another aspect of the present invention, there is provided a dryer including: a control panel; a display mounting part formed on the control panel and on which a display device is installed; and a detachable button disposed on the display mounting part to divide the display mounting part into a required area.

In a further another aspect of the present invention, there is provided a dryer including: a control panel; a display mounting part formed on the control panel and on which a display device is installed; a detachable button disposed on the display mounting part to divide the display mounting part into a required area; and a button holder combined with the detachable button to be detachable.

According to the present invention, an either an LED or an LCD is selectively mounted on one control panel, and thus necessary buttons are easily added.

Accordingly, a change of a mold for manufacturing a control panel, which depends on diversity of a model, may be minimized. Therefore, cost for manufacturing the mold may be reduced and also compatibility and expandability of the control panel may be improved.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a front view illustrating a dryer including a control panel according to an embodiment of the present invention;

FIG. 2 is a perspective front view illustrating a control panel according to an embodiment of the present invention;

FIG. 3 is a perspective rear view of the control panel in FIG. 2;

FIG. 4 is an enlarged perspective view illustrating a button holder mounted on a control panel according to an embodiment of the present invention;

FIG. 5 is a perspective view illustrating a detachable button mounted on a button holder of a control panel according to an embodiment of the present invention;

FIG. 6 is a plan view of when an LED is mounted on a display mounting part; and

FIG. 7 is a plan view of when an LCD is mounted on the display mounting part.

### DETAILED DESCRIPTION OF THE INVENTION

Reference will now be made in detail to the preferred embodiments of the present invention, examples of which are illustrated in the accompanying drawings. However, the spirit and scope of the present invention may not be limited to the embodiments herein. Moreover, other embodiments may be easily proposed, which will be construed as being included within prior art inventions or the spirit and scope of the present invention by addition, change, deletion of other components.

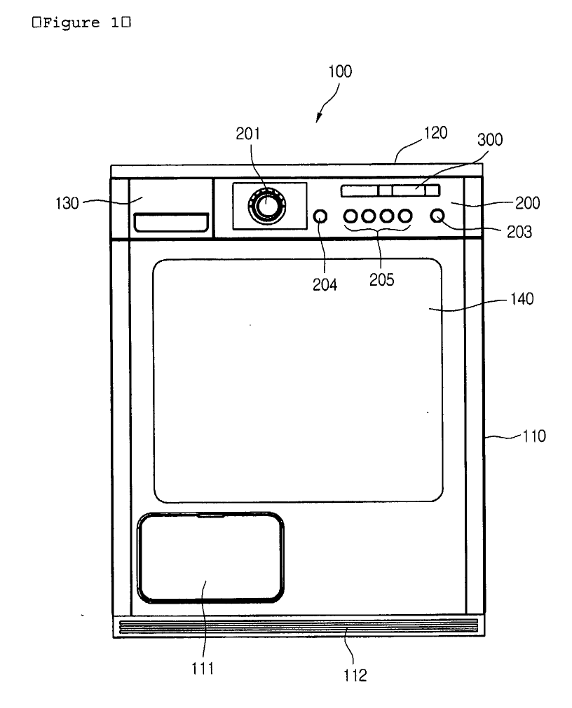

FIG. 1 is a front view illustrating a dryer including a control panel according to an embodiment of the present invention.

Here, a dryer is used for an example, but the present invention is not limited to the dryer.

Referring to FIG. 1, a dryer 100 includes a case 110, a door 140, a top cover 120, a control panel 200, and a drawer 130.

The case 110 forms an external of the dryer 100, and includes a dry drum (not shown) therein. The door 140 is mounted on a front of the case to be rotatable, and opens and closes a front part of the dry drum. The top cover 120 covers a top of the case 110. The control panel 200 is mounted on a top of the door 140 to input drying conditions and a drying time, and includes a display part displaying an operation status. The drawer 130 is disposed on one end part of the control panel 200, and inserted to be detachable to the inside of the case 110. Thus, condensate water can be stored.

An indoor air inlet 112 is formed on a front bottom of the case 110. An indoor air can be flown into the inside of the dryer 100 through the indoor air inlet 112. Moreover, a condenser cover 111 is formed on a top of the indoor air inlet 112. A condenser (not shown) is installed on a rear of the condenser cover 111. The condenser heat-exchanges an indoor air inhaled through the indoor air inlet 112 with a circulating air circulated in the dry drum.

The control panel 200 includes a dial knob 201, a display device 300, a power button 203, an operation button 204, and a drying condition setting button 205. The dial knob 201 inputs drying conditions of the dryer. The display device 300 displays diverse information (i.e. drying status) of the dryer 100. The power button 203 applies a power source to the dryer 100. The operation button 204 starts a drying cycle. The drying condition setting button 205 sets various drying conditions of laundry.

Operations of the dryer 100 including the above components will now be briefly described.

First, a user opens the door 140 and throws the laundry of a drying object into the dryer 100. Next, the user presses the power button 203, and then a power source is applied to the dryer 100. When the user controls the dial knob 201 and/or the drying condition setting button 205, the drying conditions of the laundry are determined. Therefore, when the user presses the operation button 204, the drying cycle starts.

Information of the operation status of the dryer 100 is displayed in the display device 300. A user verifies a performing status of the drying cycle of the dryer 100 through diverse information, i.e. a drying status, a drying time, etc., displayed on the display device 300.

On the other hand, when the drying cycle starts, the dry drum rotates and thus laundry is repetitively tumbled in the dry drum. Additionally, a hot wind is flowed into the inside of the dry drum, and absorbs moisture of the laundry. During the drying, the absorbed moisture from the laundry is converted into condensate water in the condenser, and the condensate water is stored inside the drawer 130. Through these processes, the laundry can be dried.

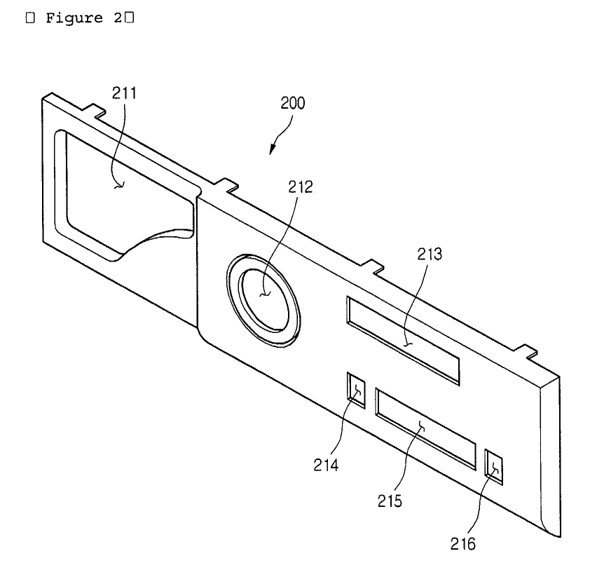

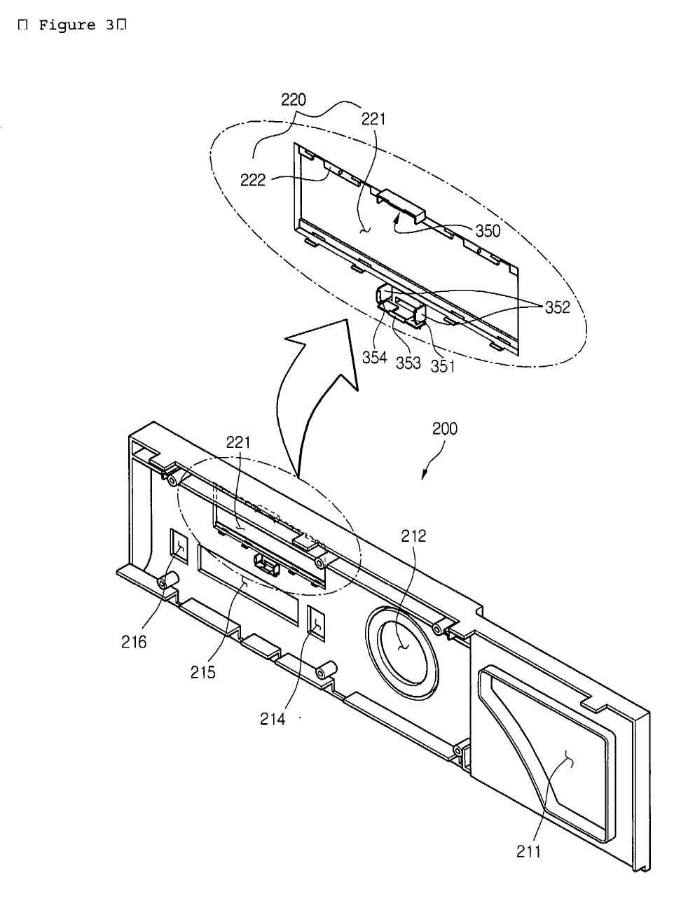

FIG. 2 is a perspective front view illustrating a control panel according to an embodiment of the present invention and FIG. 3 is a perspective rear view of the control panel in FIG. 2.

Referring to FIGS. 2 and 3, a control panel 200 includes a drawer insertion hole 211, a dial knob insertion hole 212, a display mounting part 220, an operation button insertion hole 214, and a power button insertion hole 216.

The drawer insertion hole 211 is formed on one side of the control panel 200, and then the drawer 130 is inserted. The dial knob insertion hole 212 is formed on the approximately center of the control panel 200, and thus the dial knob 210 is inserted through. The operation button 204 is inserted into the operation button insertion hole 214. The drying condition setting buttons 205 are inserted into the drying condition setting button insertion hole 215. The power button 203 is inserted into the power button insertion hole 206.

The display mounting part 220 includes a display mounting hole 221 and a display support rib 222. The display device 300 of the LCD 330 or the LED 320, and buttons (mentioned later) are mounted on the display mounting hole 221. The display support rib 222 is formed around the display mounting hole 221. When the display device 300 is installed on the display mounting hole 221, the display support rib 222 is combined with a predetermined portion of the display device 300. Then, the display device 300 may be fixed at the display mounting part 220 using the display support rib 222.

Here, a plurality of the display support ribs 222 may be formed to be spaced apart from each other with a predetermined distance. Then, the display device 300 is supported by a plurality of positions of the display support ribs 222. Accordingly, the display device 300 may be fixed at the display mounting part 220 more reliably.

Button holders 350 are formed around the display mounting hole 221. Specifically, the button holders 350 are formed on a top and a bottom of the approximately middle of the display mounting hole 221. The button holders 350 are formed to face each other. A detachable button 340 of FIG. 2 such as a reservation button or a multi-language switch button is mounted on the button holder 350. A front of the detachable button 340 mounted on the button holder 350 faces a front of the control panel 200. The display support ribs 222 may be formed on both sides of the button holder 350.

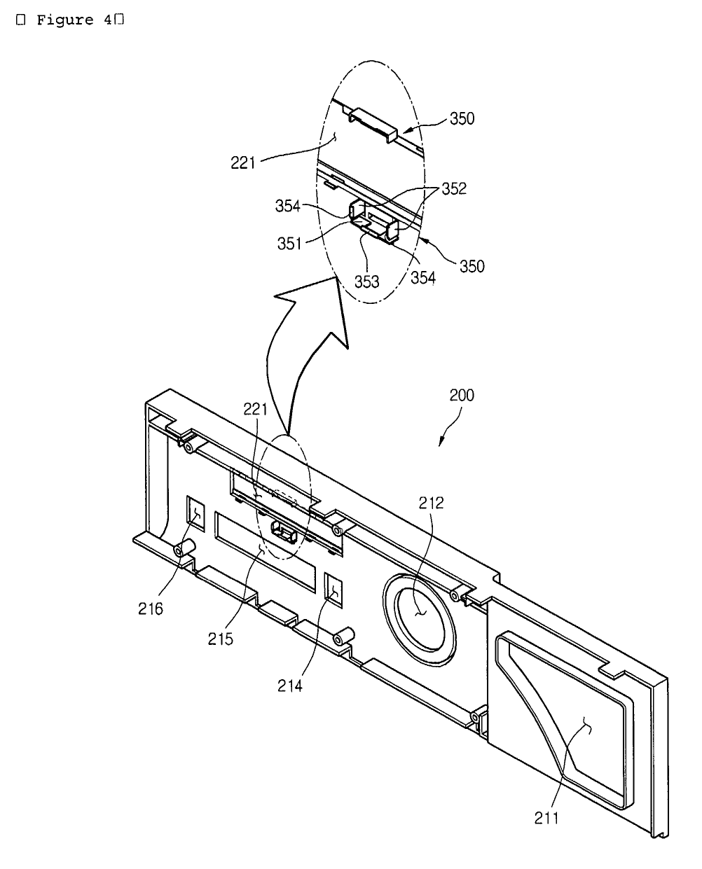

The button holder 350 includes a button receiving part 351, a button supporting part 352, and button retaining protrusions 353 and 354. The button holder 350 will now be described in more detail with reference to FIG. 4.

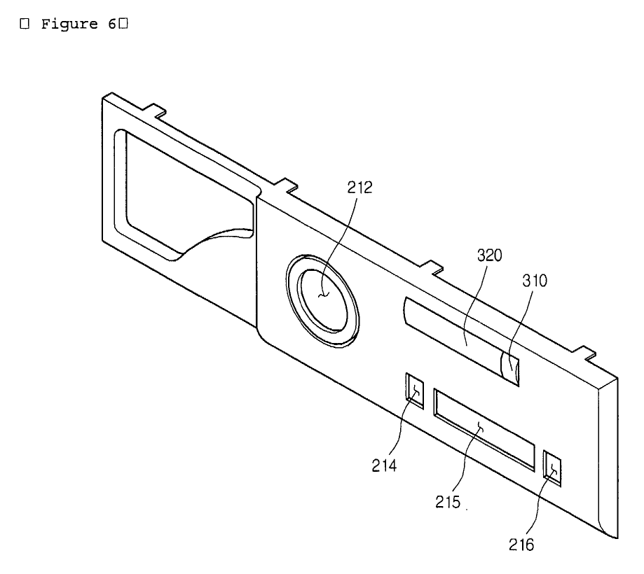

Using the configuration as described in the above, the reservation button 310 of FIG. 6 is mounted on one side edge of the display mounting part 220, and also the LED 320 may be mounted in a side direction of the reservation button 310. Moreover, a detachable button (e.g. the multi-language switch button) may be mounted on the button holder 350, and the LCD 330 may be mounted on both sides of the detachable button.

FIG. 4 is an enlarged perspective view illustrating a button holder mounted on a control panel according to an embodiment of the present invention.

Referring to FIG. 4, the button holders 350 are formed on a top and a bottom of the display mounting part 220 and combined with a top and a bottom of the detachable button 340.

The button receiving part 351 supports the detachable button 340 mounted on the button holder 350. The button supporting part 352 is formed of a perpendicularly cut shape toward the display mounting hole 221 in the button receiving part 351. The button supporting parts 352 are formed on the both sides of the button receiving part 351. Then, the button supporting parts 352 prevent a vibration of the detachable button 340 in a side direction. The button retaining protrusions 353 and 354 are formed of a perpendicularly cut shape in end parts of the button receiving part 351 and the button supporting part 352. The button retaining protrusions 353 and 354 prevent arbitrary separation after the detachable button 340 is combined with the button holder 350. The detachable button 340 is forcibly inserted by an external force and stuck into the button retaining protrusions 353 and 354.

Using the configuration as described in the above, when the detachable button 340 is installed on the button holder 350, the top and the bottom of the detachable button 340 are supported by the button receiving part 351 and the button supporting part 352. The rear of the detachable button 340 is supported by the button retaining protrusions 353 and 354. Accordingly, even if external impact and vibration are applied, the detachable button 340 is not separated from the button holder 350, and fixed stably.

Here, forming locations and the number of the button holder 350 are not limited to an embodiment of the present invention, and if necessary, various numbers of locations and button holders 350 can be possible.

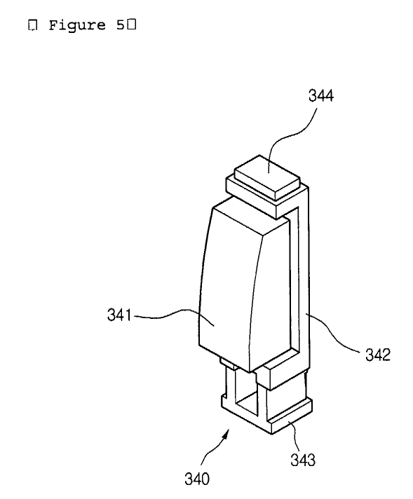

FIG. 5 is a perspective view illustrating a detachable button mounted on a button holder of a control panel according to an embodiment of the present invention.

Referring to FIG. 5, the detachable button 340 includes a button body 341, a button frame 342, a bottom insertion end part 343, and a top insertion end part 344.

The button body 341 is pressed by a user, and may be formed of a curved surface with a predetermined curvature to improve the sense of touch. The button body 341 is surrounded by the button frame 342. The button frame 342 surrounds and supports the button body 341. Additionally, the button frame 342 may have some resilience in a front and back direction. The bottom insertion end part 343 and the top insertion end part 344 are formed on the top and the bottom of the button frame 342, respectively. The top insertion end part 344 and the bottom insertion part 343 are inserted into the button holders 350, respectively, and the detachable button 340 is fixed at the button holders 350.

Specifically, the bottom insertion end part 344 is mounted on the button receiving part 351 of the button holder 350 such that the detachable button 340 is mounted the button holder 350. Moreover, some depth of a groove, into which the button supporting part 352 is inserted, is formed on a rear of the bottom insertion end part 343. The supporting part 352 is inserted into the groove to prevent a vibration of the detachable button 340.

The detachable button 340 can be mounted on the button holder 350, and if necessary, removed from the button holder 350. That is, since the detachable button 340 is easily detachable to the display mounting part 220, buttons for additional functions can be added and removed easily. Accordingly, without a shape change of the control panel 200, required buttons can be easily added and removed. Therefore, a change of a mold of the control panel 200 is minimized, and functions of the control panel 200 can be easily added and removed. Finally, the control panel 200 becomes compatible between the products.

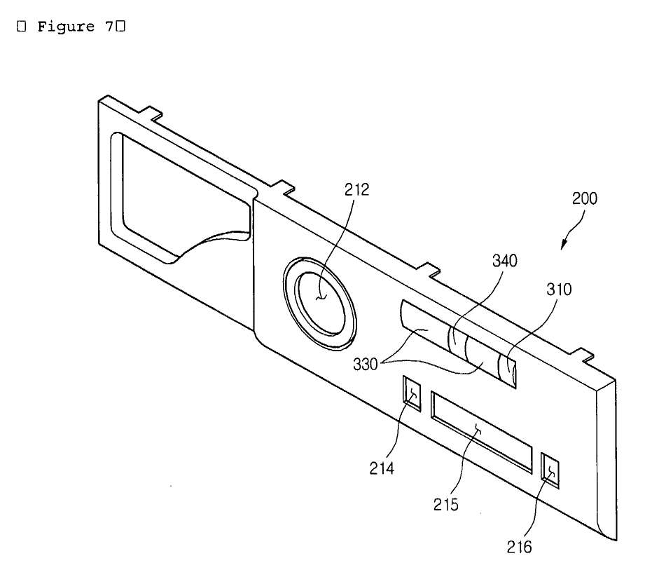

FIG. 6 is a plan view of when an LED is mounted on a display mounting part. FIG. 7 is a plan view of when an LCD is mounted on the display mounting part.

Referring to FIGS. 6 and 7, the display mounting part 220 can be divided into a predetermined space by the detachable button 340. The display device 300 may be mounted on the space divided by the detachable button 340. The display device 300 can be the LED 320 or the LCD 330. That is, either the LED 320 or the LCD 330 is selectively mounted on the control panel 200 of the same shape.

Specifically, when the LED 320 is mounted on the display mounting part 220, the reservation button 310 may be mounted on one side edge of the display mounting part 220. Next, the LED 320 may be mounted on the remaining space of the display mounting part 220. The drying status, etc. may be displayed through the LED 320.

On the other hand, when the LED 330 is mounted on the display mounting part 213, the detachable button 340 such as the multi-language switch button, which is additional to the reservation button 310, may be mounted on the display mounting part 213.

Additionally, the LCD 330 may be mounted on both sides of the detachable button 340. In this case, a language, which represents a drying status, may be displayed on the LCD mounted on the left of the detachable button 340. The language displayed on the LCD 330 may be changed by the detachable button 340. When error occurs during a drying process, an alarm signal may be displayed on the LCD 330. A drying reservation time set by the reservation button 310 may be displayed on the LCD 330, which is mounted the right of the detachable button 340.

According to the display device mounted on the display mounting part 220, a button holder is formed to add more buttons. Thus, either the LCD 330 or the LED 320 is selectively mounted on one control panel 200. Accordingly, compatibility of the control panel 200 can be improved.

Moreover, since the number of the button holders 350 formed on the display mounting part 220 is appropriately adjusted, the display mounting part 200 may be divided into a plurality of display windows. Thus, expandability of the dryer for improving performance increases.

Using the configuration as described in the above, either an LED or an LCD may be selectively mounted on one control panel, and necessary buttons may be added easily.

Accordingly, a change of a mold for manufacturing a control panel according to various models is minimized, and expense for manufacturing the mold is reduced. Additionally, compatibility and expandability of the control panel may be improved.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dryer comprising:
a control panel;
a display mounting part formed on the control panel and on which a display device is installed;
a detachable button disposed on the display mounting part; and
a button holder holding the detachable button to be detachable.

2. The dryer according to claim 1, wherein the detachable button is forcibly inserted into the button holder.

3. The dryer according to claim 1, wherein the button holder is formed on a rear of the control panel.

4. The dryer according to claim 1, wherein the button holder supports the detachable button at both sides of the detachable button.

5. The dryer according to claim 1, wherein the button holder includes a button receiving part receiving the detachable button, and a button supporting part supporting sides of the detachable button.

6. The dryer according to claim 1, wherein the button holder includes a button retaining protrusion contacted with the detachable button to prevent separation of the detachable button.

7. The dryer according to claim 1, wherein the button holders are formed on a top and a bottom of the display mounting part, respectively.

8. The dryer according to claim 1, wherein a plurality of the button holders are formed to face each other.

9. The dryer according to claim 1, wherein the display device is installed on at least one side of the detachable button in the display mounting part.

10. The dryer according to claim 1, wherein the display device is installed on both sides of the detachable button in the display mounting part.

11. The dryer according to claim 1, wherein the detachable button includes a button body pressed by a user, and a button frame supporting the button body.

12. The dryer according to claim 1, wherein the detachable button includes an insertion end inserted into a predetermined portion of the button holder such that the detachable button is fixed at the button holder.

13. The dryer according to claim 12, wherein the insertion ends are formed on a top and a bottom of the detachable button, respectively.

14. A dryer comprising:
a control panel;
a display mounting part formed on the control panel and on which a display device is installed; and
a detachable button disposed on the display mounting part to divide the display mounting part into a required area.

15. The dryer according to claim 14, wherein the detachable button is installed on the display mounting part to be detachable.

16. The dryer according to claim 14, wherein a button holder is formed to combine with the detachable button in the control panel.

17. The dryer according to claim 14, wherein the display device is installed on each area of the display mounting part, which is divided by the detachable button.

18. The dryer according to claim 14, wherein the display device is an LCD (liquid crystal display) or an LED (light emitting diode).

19. The dryer according to claim 18, wherein both the LCD and the LED are installed on each area of the display mounting part, which is divided by the detachable button.

20. A dryer comprising:
a control panel;
a display mounting part formed on the control panel and on which a display device is installed;
a detachable button disposed on the display mounting part to divide the display mounting part into a required area; and
a button holder combined with the detachable button to be detachable.
